(19) United States
(12) Patent Application Publication
(10) Pub. No.: US 2007/0209224 A1
(43) Pub. Date: Sep. 13, 2007

(54) METHOD AND APPARATUS FOR DETERMINING THE NORMAL DISTANCE BETWEEN A PLANE AND A POINT

(75) Inventor: James Terry Bush, Mooresville, NC (US)

Correspondence Address: JAMES TERRY BUSH, 173 CRYSTAL BAY DR., MOORESVILLE, NC, 28115, US

(73) Assignee: James Terry Bush, Mooresville, NC (US)

(21) Appl. No.: 11/534,216

(22) Filed: Sep. 21, 2006

Related U.S. Application Data
(60) Provisional application No. 60/718,870, filed on Sep. 21, 2005.

(51) Int. Cl. G01B 3/22

(52) U.S. Cl. 33/832

(57) ABSTRACT

An improved gauge for determining the distance between a plane and a point includes a contact probe allowed to rotate within a support frame and coupled to a rotary sensor. When released, force provided by an energizing device urges the probe from the start position, normal to the start plane, to the measured point. As the contact probe moves toward and makes contact with the measured point, output from the rotary sensor is translated through a microprocessor and interpreted through an equation as a normal distance from the start point to the contact surface of the probe. The resultant of the equation is displayed onto a digital readout. The digital readout features a touchpad interface which allows the user to control measurement units, power controls and default start points. In addition to individual readouts, this apparatus may be applied to a multi-readout embodiment which displays the outputs from multiple devices on a single output display.

### FIELD OF ENDEAVOR

The present subject matter relates to techniques and equipment for determining the distance between a plane and a point.

### BACKGROUND

This invention relates to length measurement apparatus, more particularly to a novel method and apparatus for measuring the normal distance between a plane and a point. The invention also relates to the measurement between two objects wherein one object is raised above another object and the vertical distance between the two objects must be measured. This is particularly important for measuring the corner stance elevations of square or asymmetrical objects where the desired corner height differs from fore to aft, as well as from left to right. The automobile and more predominantly, the automobile used in autoracing is a prime example of such a case. In automobile chassis physics, the static height at a particular chassis corner affects the dynamic weight transfer during vehicle cornering. A proper chassis setup balances static ride height and respective corner weight to create optimal weight transfer as the vehicle negotiates a turn.

In the case of the automobile chassis, the necessity for corner height measurements has emerged because of advancements in the knowledge of vehicle dynamics and handling throughout the decades of the latter half of the 20^{th} century. Modern automotive engineers understand that the handling of all four-wheeled vehicles is partially dependent on the weight imposed on each wheel of the vehicle during cornering. The weight imposed on each wheel is translated through the chassis during body roll and is proportional to the dynamic weight transfer about the rotational axis of the vehicle. Weight transfer to and from each wheel can be adjusted by pre-setting the static weight and chassis height on each corner of the car. Optimal performance in automobile chassis may be attained by lowering or raising one chassis corner relative to the other corners. In the case of the racing automobile and especially the racing automobile made to turn in only one direction, chassis corners are set asymmetrically in height as well as static weight. Sanctioning bodies in auto racing have made provisions for these staggered heights. In the interest of avoiding unsafe or unfair conditions, they have limited the minimum and maximum heights allowable at each corner of the chassis. The physical advantages of staggered corner heights, paired with a need to observe association rules has made corner height measurement an essential step in setting up a racing automobile.

### DESCRIPTION OF PRIOR ART

There are various methods and devices available for use in measuring the distance between objects, but heretofore there has been no satisfactory system for outputting a highly visible electronic measurement result while maintaining hands-free contact with the measurement surface. Nor yet has there been such a device which outputs digital measurements in fractional form as is needed for users referencing the English measurement system.

An example of prior art as seen in U.S. Pat. No. 6,912,477, issued to Patrick Murray on Jun. 28, 2005, discloses a multi-sensor device which moves and measures in three dimensions. The output of such a device is a spherical coordinate which would require in-depth knowledge of trigonometry to interpret. In addition, the device does not provide a means of maintaining contact with the measured point. Lastly, the use of more than one rotary sensor would make the device unaffordable to the average user.

In yet another example of prior art, U.S. Pat. No. 6,381,864, issued to Michael L. Hayes on May 7, 2002 discloses a fairly simplistic mechanical distance measurement gauge comprised of a scissoring insert with etched tick marks inside a housing from which it is sprung, locked into position and read by the user. This gauge introduces the same inaccuracies common to rulers and tape measures as well as tick-mark interpretation errors, eye strain from reading the gauge in dimly-lit areas and the rigmarole of reducing English fractional measurements to a least common denominator.

Users of the invention described herein will find the solution to the abovementioned challenges particularly valuable when using this device to measure distances underneath racing automobiles. A common practice used in race car setup is corner weight/height balancing. The most common method of corner weight balancing utilizes digital corner weight scales placed under each tire of the car. Using the scale readings to balance the corner weights, each corner of the chassis raised or lowered to strike the correct balance of corner height and weight. Height measurements are made with a tape measure placed on the ground and extended to the measured point. The proportional relationship between corner height and corner weight means that this method requires each of the four corners be weighed and measured several times before the proper balance is reached. Using this method, the user may experience awkward body positioning, eye strain from reading tape marks in a dimly-lit area and the prospect of circling all four corners of the car several times. Time is also wasted by factoring fractional tape measure marks to the least common denominator—a common practice in the fractional English system of measurement.

Race car chassis setup is merely one use for this device. There are many other uses for this concept outside of the realm of the automobile. The use of this apparatus is useful on any application requiring the normal distance between a plane and a point.

### OBJECT(S) OF THE INVENTION

It is an object of this invention, to provide an improved apparatus for measuring distances between objects hands-free while standing upright.

Another object of this invention is to provide accurate, repeatable measurement accuracy through the use of electronic sensors that provide resolution in excess of that which can be found on common measuring tapes or other measuring apparatuses.

A further object of this invention, through the signal reception, wireless or wire connected, of more than one individual and independent device by a single centralized output display or computer, is to allow several measurements to be conducted simultaneously.

Furthermore, it is an object of this invention to utilize the computational logic from a microprocessor to interpret a signal from a rotary sensor and display interpreted results as accurate measurements of length.

Another object of this invention is to abridge the process of vehicular chassis geometry adjustment through the visibility of real-time hands-free measurement.

Concomitantly, an object of this invention is to provide a measurement device utilizing a probe which maintains contact with measurement surfaces through spring action.

Yet another object of this invention is to provide the ability to measure and read said dimensions in dimly-lit areas.

Concurrently, an object of this invention is to provide digital measurement readings in fractional as well as decimal form.

Other objects of the invention will be apparent hereinafter from the specification, and from the recital of the appended claims, particularly when viewed in conjunction with the accompanying drawings.

### SUMMARY OF THE INVENTION

This invention is modular in design and therefore may be utilized as an individual device or as several communicating devices providing multiple simultaneous measurements on a single display.

The individual embodiment of the device consists of frame in which a mechanical probe pivots and is coupled to a rotary sensor. Movement of the probe is translated to the sensor in the form of angular rotation. The sensor output is interpreted by a computer processor integral to the device as a variable in an equation, which is then solved. The result of the calculation is the normal distance that the tip of the probe has traveled from its original position. The result is instantaneously displayed on a digital readout which can take forms including liquid crystal displays (LCDs), light emitting diodes (LEDs) and cathode tubes. Integral with the display is a push-button control panel which allows control over the display and output of measurement results.

The multi-device embodiment consists of all of the same components of the individual embodiment with the addition an auxiliary device to receive and interpret readouts from multiple individual devices. A central display on the auxiliary device, connected via wire or wireless transmission to each individual device, displays the result of each individual device on a single display. The auxiliary device may take the forms including a laptop, desktop computer or a dedicated display device which simply transmits display results without a graphic user interface.

### BRIEF DESCRIPTION OF FIGURES

FIG. 1 is a rendering of the device in a fully assembled state, enclosed by a protective housing. Also shown are the electronic display characters protruding through the housing.

FIG. 2 is a view normal to one possible configuration of the touchpad interface. Depicted are control buttons surrounding the output screen.

FIG. 3 is a transparent depiction of the internal workings of the device including: probe arm, gear reduction, rotary measurement device, support channel, spring and stilt release mechanism.

FIG. 4 is a photograph depicting the current method of attaining measurements from the ground to a vehicle chassis with a tape measure.

FIG. 5 depicts the proposed method of attaining ground-to chassis measurements using the abovementioned apparatus.

FIG. 6 is a side-view schematic of the device with superimposed variables used in the height-calculation logarithm.

FIG. 7 exhibits an embodiment of the device which is equipped with a remote connection (wireless or wire-connected) and communicates with a remote computer to display outputs from multiple devices simultaneously.

### DETAILED DESCRIPTION OF THE PREFERRED EMBODIMENT(S)

The apparatus described herein and description of techniques for utilizing it relate to determination of the distance between a plane and a point residing in space above or below the plane. Determination of such a distance requires determining a set of 2-dimensional coordinates—one representing a point on the plane of reference, hereafter referred to as the base point, and one representing the measured point above or below the plane of reference. Performing the measurement requires first setting the start point, or base, which resides a pre-set distance from the referenced plane. In the embodiment referenced in the figures, base is achieved when the contact probe is at the horizontal position. Next, the probe is urged to make contact with the measured point. The measured point may be virtually any distance from the referenced plane. Its location need not be specified by a manufacturer or fixed in space. It must simply be available for direct contact by the contact probe extending from the measurement device. A measurement is taken by extending the contact probe from the base point to the measured point and determining the change in distance between the two points. The measurement result is displayed on an electronic display.

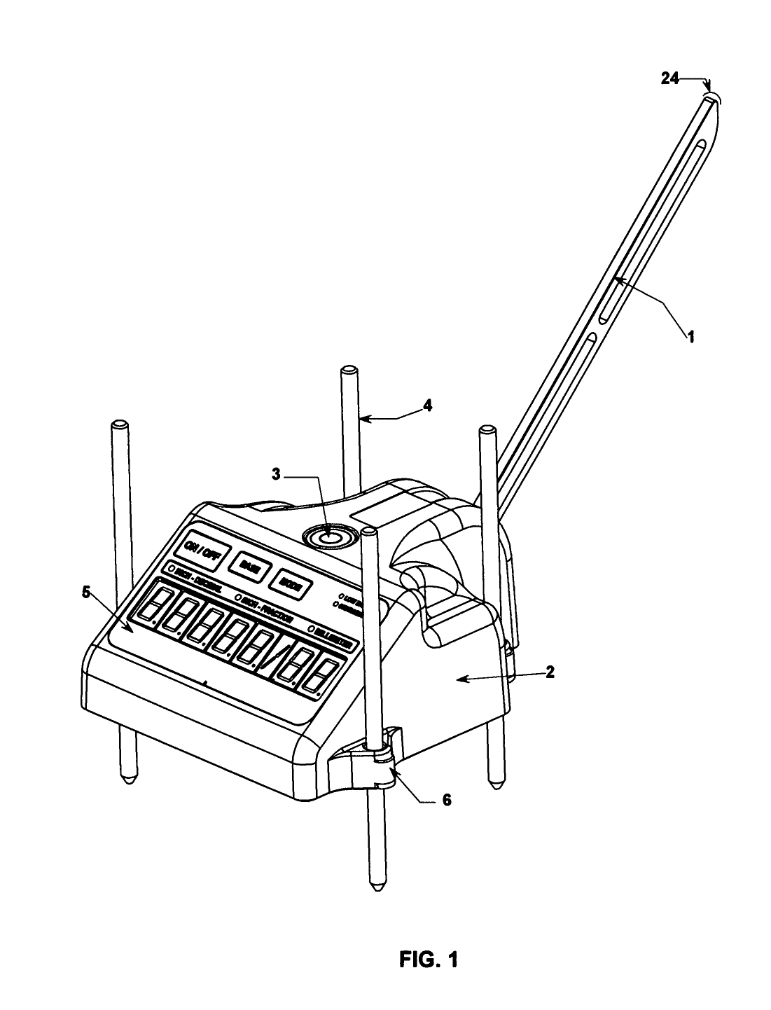

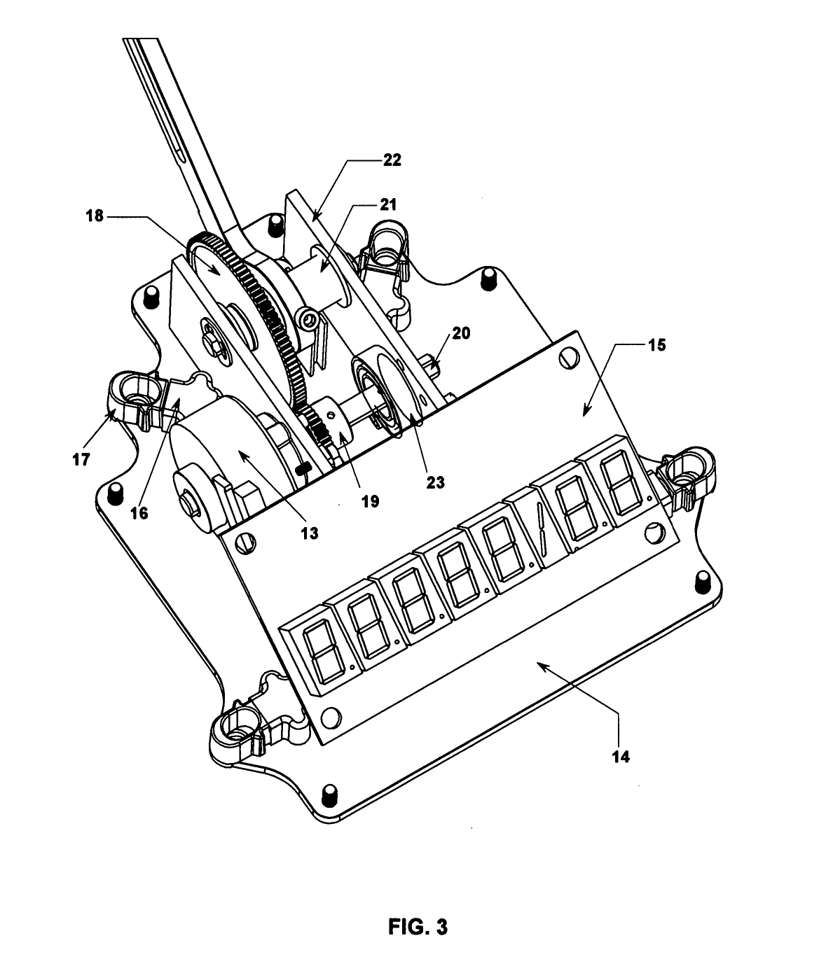

Referring now to the drawings by numerals of reference, and initially FIGS. 1 and 3, a gauge representing one preferred embodiment of the apparatus includes a base plate 14 parallel to the plane of reference and sufficiently flat to provide a planar surface on which a u-shaped frame 22 is mounted. In the center of the frame 22 resides a semi-rectangular arm with a pointed or slightly rounded tip, hereafter referred to as the contact probe 1. The contact probe 1 is attached to a shaft, hereafter referred to as the probe shaft 21, which pierces laterally through the contact probe 1 as well as both side walls of the frame 22. The probe shaft 21 is concentric to the pivotal fulcrum of the contact probe 1 and is coupled to it in such fashion that as the probe shaft 21 is rotated to any degree, the contact probe 1 will rotate to the same degree. The probe shaft 21 passes through the frame 22 side walls in such fashion that it is allowed to rotate freely, but is captured within the frame 22 by fasteners. There is yet a second shaft mounted to the frame 22 in the same fashion as the probe shaft 21. It rotates parallel to the probe shaft 21, and hereafter will be referred to as the drive shaft 20. The drive shaft 20 is coupled to an energizing device 23 which may take forms such as a torsion spring, motor or pneumatic actuator. Stored energy from the energizing device 23 acts on the drive shaft 20, causing it to turn. Coupled also to the drive shaft 20 is a rotary sensor 13 mounted solidly to the frame 22, which is also turned with the drive shaft. A gear, hereafter referred to as the drive gear 19 is mounted solidly to the drive shaft 20 and in mesh with another gear solidly coupled to the probe shaft 21, hereafter referred to as the probe gear 18. The probe gear 18 and the connected contact probe 1 are rotated by torque translated through the drive gear 19. In this sense, rotation of the drive shaft 20 translates through a gear multiplier into rotation of the contact probe 1, urging it upward until it contacts the measured surface. Rotation of the drive shaft 20 over the movement of the contact probe 1 is recorded by the sensor 13 and displayed on the output screen.

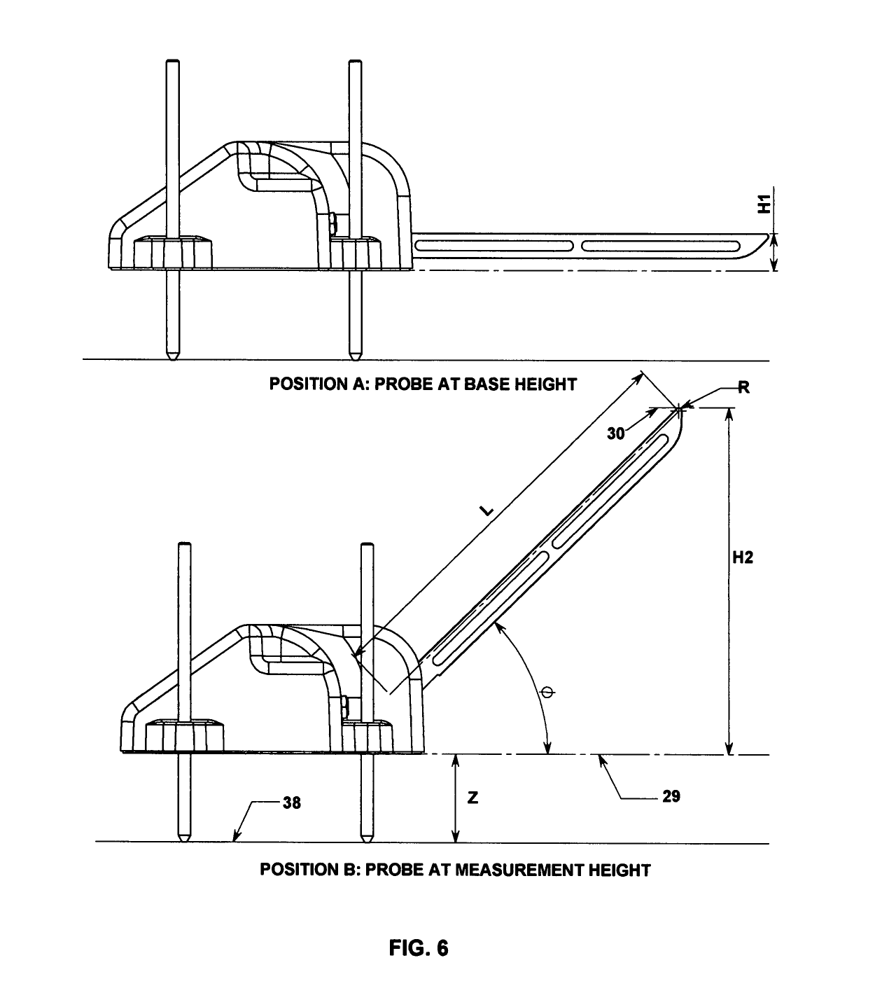

Demonstrated also in FIGS. 1 and 3 is a mechanism integral to the abovementioned preferred embodiment which allows the plane of reference to be adjusted to measure objects offset from a solid plane by a factor of Z (FIG. 6). An example of such a case is a vehicle placed on wooden blocks. In such an instance, the height of the chassis from the ground is offset by the wooden blocks. To compensate for the additional height without the need to subtract the thickness of the blocks from the measurement, adjustable stilts 4 are placed around the device. The device can be placed on the offsetting object (in this case, a wooden block) and the stilts 4 lowered such that the reference plane of the device is at the level of the top of the object. In the preferred embodiment shown, the stilts 4 are adjusted by pressing a spring loaded plunger 17 into a guide, thus releasing the frictional bind on the stilt 4. Releasing the spring plunger will then restore friction to the stilt 4, allowing the device to be supported.

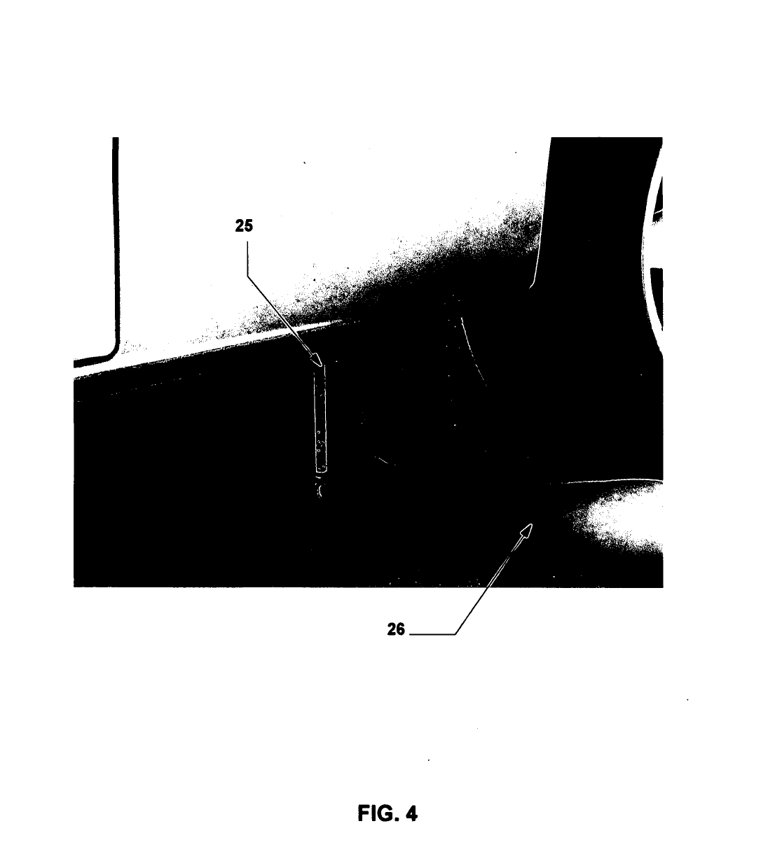

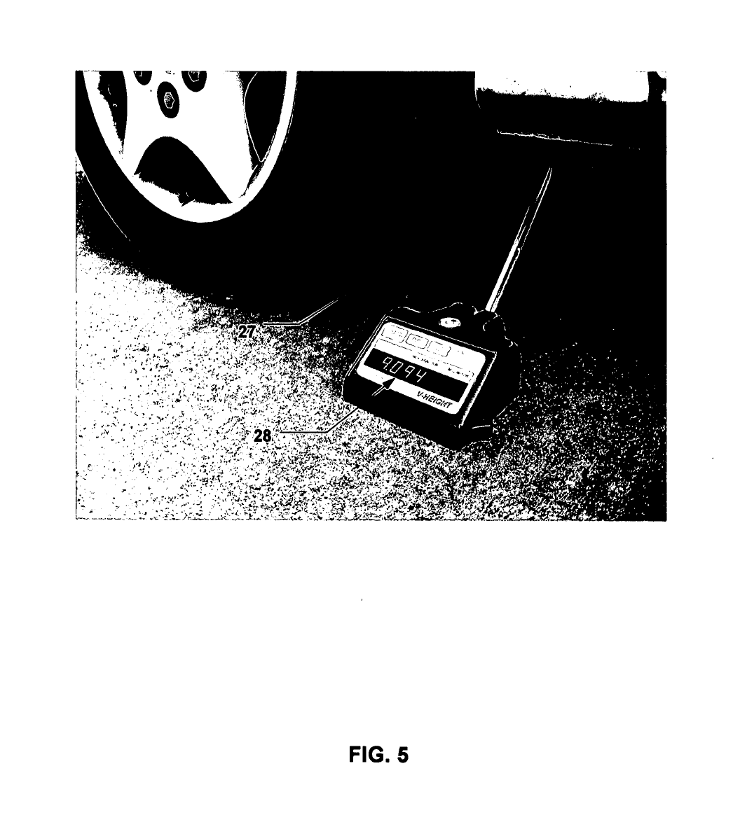

Now referring to FIGS. 4 and 5, FIG. 4 depicts the most widely accepted method for measuring the under-side of objects, and in this case an automobile. The arm 26 of the user is shown on the ground, supporting a common tape measure 25. The housing of the tape is placed on the ground and the metal tip of the tape is extended to contact the measured object. The arduous nature of positioning the tape measure while lying on the ground is evident. In addition, it is difficult to read the tick marks on the tape when it is placed in the shadowed overhang of the vehicle. Using this method, inaccuracies are caused by using an unleveled tape and propagated by misinterpretation of the tick marks and their relation to the tape housing. In automotive racing particularly, measurements such as these are carried out frequently. Decreasing the time technicians spend on the ground is a pressing concern in modern automotive racing companies.

In FIG. 5, one preferred embodiment of the apparatus is shown performing the same measurement as described above. In this example the device rests on the ground plane, which in this case is the reference plane. The contact probe rests in contact the measured surface, in this case the under-chassis of the automobile. The display screen of the device slanted at an upward angle and electronically lit such that the user, standing upright, may easily read the measurement from the ground to the underside of the chassis while maintaining an upright stance, regardless of the dim location caused by the shadow of the vehicle. By reading the measurement directly from the output screen, the user is free from tick mark interpretation. Additionally, the preferred embodiment features a bubble level (FIG. 1) 3 integral to the housing which ensures the device is level when taking measurements.

As may be observed in FIG. 6, while the contact probe 1 rotates, the absolute distance between the measured surface 30 and the pivotal fulcrum, L, acts as a hypotenuse in a right-triangle. The pointed or slightly rounded tip of the contact probe 1, hereafter referred to as the measurement surface (FIG. 1) 24, is at a pre-determined distance from the rotational fulcrum of the contact probe 1. Other mechanical dimensions of the contact probe 1 and frame 22 introduce constant variables into the equation. These variables include the radius of the rounded tip of the measurement surface, R, and the original height of the measurement surface center from the reference plane, Z. The variable of interest is the angular rotation Θ of the contact probe 1 about its fulcrum. The sensor used to quantify angular rotation Θ may take forms including but not limited to rotary encoders, LVDTs, string pots or hall-effect sensors. In any case, the sensor 13 signal is interpreted by a microprocessor integral to the circuit board 15. The microprocessor inserts the signal as a variable in a pre-programmed trigonometric equation. When solved, the direct vertical distance the measurement surface has traveled from its original position, H1, may be determined as H2 as observed, given the following:
H2=L sin Θ+H1+R+Z

FIG. 6, also features position A and position B, depicting the basic movement of the contact probe 1. While the arm is lowered A, the probe tip is at the base position and is thus allowed to reach very low areas. The display output reflects the position of the probe arm. When extended B, the arm is able to reach objects much higher than at its initial position. The scissoring action of the contact probe is essential to this invention in that it is able to measure underneath objects low to the ground, while maintaining the ability to reach higher objects.

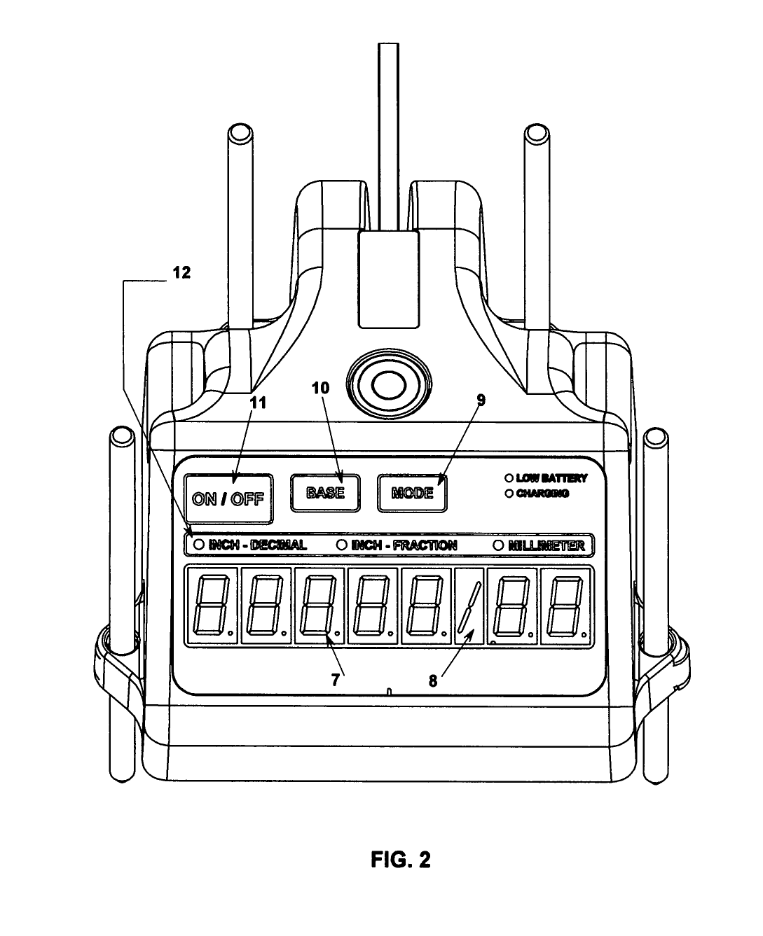

In the preferred embodiment of the device button interface shown in FIG. 2, the front of the display board features electronic output characters 7, 8 and buttons 9, 10, 11 which control the output display the microprocessor. The user may push buttons on the interface to control the measurement result output in several ways. One control button 9, when toggled, provides the choice of numeric output measured in English decimal units (10.88 inches), English fractional units (e.g. 10 3/16 inches), rounded to the least common denominator of the smallest fractional measurement increment, or metric decimal units (e.g. 13.4 millimeters). A second button 10 allows the user to set the device at its base, when pressed, causing the display to read the base measurement, which is the height of the probe when it is at its lowest position. A third button 11, when pressed, will cause the device to power on or off. In addition to buttons, several lights on the display signal necessary attention to the device as well as modes of operation. For instance, the light 12 next to the unit type signifies that a particular unit type (e.g. inch fraction) is displayed when lit.

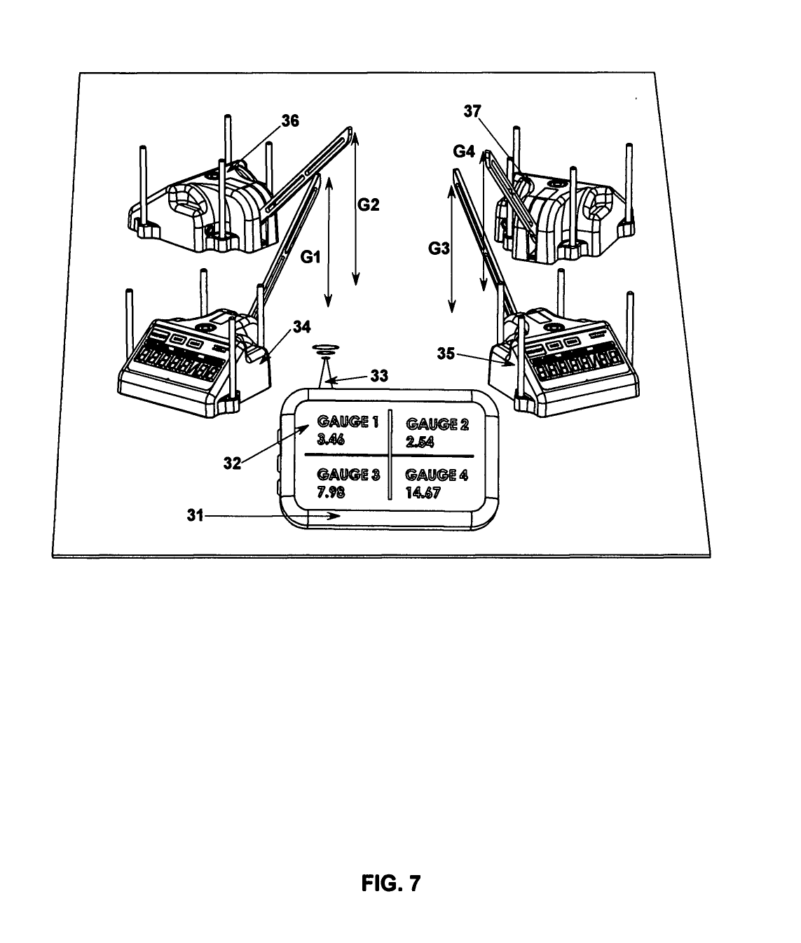

Referring to FIG. 7, which depicts the multi-device embodiment of the apparatus, a central auxiliary output device 33 can be used to collect multiple signals from several devices 34-37. Using this multi-device embodiment, the user can view the results of several measurements 32 simultaneously. Each individual height measurement G1-G4 may be transmitted to the auxiliary device 33 via cable or communicate via wireless signal.

The device is designed to be a versatile, compact and durable instrument. In operating the device, the user will simply place it on a flat surface underneath the object height to be measured, and release the contact probe from its base position. Once the arm is released, the force from the torsion springs will push the arm upward until it makes contact with the surface to be measured. Once in contact, the display screen will read the exact height of the measurement surface in the selected measurement unit. The spring force will keep the probe in contact with the measurement surface without the aid of the user. This allows the user to view measurements more easily and adjust the height of the measurement surface while watching the results of the change on the gauge.

What is claimed is:

1. An apparatus for determining the normal distance between a plane and a point. The apparatus being comprised of:
A. A probe arm, a point on which makes contact with the measured point.
B. A support frame parallel to the reference plane and in which the probe arm is allowed to pivot.
C. A rotary sensor coupled directly or indirectly to the probe arm.
D. Circuit board including a micro processor, providing a measurement result given the rotary sensor input.
E. An electronic presentation of the measurement result via electronic display.
F. A touchpad which, through button control, allows user control of measurement units, power options, telemetry and measurement start points.
G. A housing covering the inner workings of the device with at least one opening through which the probe arm to protrude.

2. The apparatus in claim 1F wherein the units of the displayed measurement may be changed from decimal form to fractional form.

3. The apparatus in claim 1F wherein the format of the displayed measurement may be changed from English units to metric units.

4. The method in claim 1 wherein the device will automatically power down when unused for a specified amount of time.

5. The apparatus in claim 1E wherein measurements may be read in dimly-lit areas via illuminated digital displays.

6. The method of using such a device in an autoracing application to measure the distance between the theoretical ground plane and components on the under-side of the vehicle.

7. The apparatus of claim 1 wherein one or more separate sensor signals may be transmitted via wire or wireless transmission to an auxiliary device and presented on a common display.

8. The apparatus of claim 1 wherein the contact probe is coupled to an energizing device, such as a spring, shock, pneumatic actuator or motor, causing the probe to pivot from its initial position to the measured point.

9. The method of claim 8 wherein the contact probe remains in contact with the measured point due to force maintained by the energizing device, maintaining contact even as the measured point moves.

10. The method of claim 9 wherein transcendental changes in the height of the measured object are displayed instantaneously as the measurement probe is moved.
